(19) United States
(12) Patent Application Publication
(10) Pub. No.: US 2024/0272643 A1
(43) Pub. Date: Aug. 15, 2024

(54) Path Fusing and Planning Method for Passing Region, Robot, and Chip

(71) Applicant: AMICRO SEMICONDUCTOR CO., LTD., Zhuhai, Guangdong (CN)

(72) Inventors: Yongqiang SUN, Zhuhai,Guangdong (CN); Yongyong LI, Zhuhai,Guangdong (CN); Wu YANG, Zhuhai,Guangdong (CN)

(21) Appl. No.: 18/289,900

(22) PCT Filed: Mar. 17, 2022
(86) PCT No.: PCT/CN2022/081523

§ 371 Date: Nov. 8, 2023

(30) Foreign Application Priority Data
May 8, 2021 (CN) 202110501090.2

(51) Int. Cl. G05D 1/246; G05D 1/228; G05D 1/229

(52) U.S. Cl. CPC G05D 1/2464; G05D 1/228; G05D 1/229

(57) ABSTRACT

A path fusing and planning method for a passing region, a robot, and a chip. The robot searches for candidate paths for fusion in a narrow channel having many obstacles distributed therein in advance, and then uses a path fusing and planning method to fuse a heuristic search algorithm and the candidate routes satisfying a search condition, so as to plan an overall navigation path.

### TECHNICAL FIELD

The disclosure relates to the technical field of path planning for a robot, and in particular, to a path fusing and planning method for a passing region, a robot, and a chip.

### BACKGROUND

In some technical solutions known to the inventors, the mobile robot is a kind of robot that uses sensors to detect the surrounding environment autonomously, uses the controller to determine the movement of the machine body, and uses the actuator (such as wheels) to realize the movement. Cleaning robots often move to the narrow channel formed between various furniture components such as the four feet of the stool in the home environment, the entrance of the tea table, and the narrow channel formed by the opening of the door of the room.

When robot enters these narrow channels, due to the robot skid, the sensor used for positioning has accumulated errors or visual map optimization also produce error, so the robot can easily mark these narrow channels as areas occupied by obstacles on the instant-constructed grid map, leading to the narrow channels mapping to the robot-constructed grid map are blocked, and the actual movement scene is not really blocked. As a result, the conventional path search algorithm fails to bypass the obstacle grid marked by the map error, which is not conducive to the robot to navigate in the passable region where the marking errors are easily generated due to the fact that the channels in a grid map are narrow.

### SUMMARY

The present invention discloses a path fusion planning method, a robot and a chip for a passing area. The specific technical schemes are provided as follows.

A path fusing and planning method for a passing region, the path fusing and planning method comprising: step 1, setting a navigation starting point and a navigation ending point in a grid map, and creating a cache space of nodes to be traversed; step 2, setting the navigation starting point to a current parent node, and storing the current parent node into the cache space of the nodes to be traversed; step 3, performing a neighborhood search in the grid map with the current parent node as a search center, to search for child nodes of the current parent node, wherein, 8 grid points adjacent to the current parent node are respectively as a child node of the current parent node; step 4, when a child node searched in step 3 is an endpoint of a candidate route within a pre-searched candidate route coordinate set, storing other endpoint of the candidate route into the cache space of the nodes to be traversed; meanwhile, setting all intermediate nodes between two endpoints of the candidate route and the endpoint searched in the pre-searched candidate route coordinate set to be non-repeatable search nodes, and storing free grid points not located on the candidate route into the cache space of the nodes to be traversed; then performing step 5; wherein the candidate route is allowed to pass through obstacles grids point marked on the grid map; all the nodes stored in the cache space of the nodes to be traversed are recorded with location information of their parent node to trace back nodes later; step 5, selecting a node with a minimum sum of a path cost from the cache space of the nodes to be traversed as a next parent node, then determining whether the next parent node is the navigation ending point, in a case that the next parent node is the navigation ending point, based on the location information of the parent node recorded, connecting the child node with its parent node successively except for all the intermediate nodes and the endpoint of the candidate route in step 4, from the navigation ending point and until the navigation starting point, to plan a path from the navigation starting point to the navigation ending point; in a case that the next parent node is not the navigation ending point, updating a next parent node as the current parent node in step 3, and then performing step 3.

Alternatively, step 4 also comprising: when the child node searched in step 3 is not the endpoint of the candidate routes in the pre-searched candidate route coordinate set, storing free grid points searched in step 3 into the cache space of the nodes to be traversed, and recording location information of parent node of the free grid points searched in step 3, and then performing step 5.

Alternatively, in step 4, when the child node searched in step 3 is a starting point of the candidate route in the pre-searched candidate route coordinate set, storing an ending point of the candidate route in the cache space of the nodes to be traversed and recording location information of a parent node of the ending point of the candidate route, so that ending point of each candidate route in the pre-searched candidate route coordinate set is used as a route identification information, and setting all intermediate nodes between the two endpoints of the candidate route and the starting point the of candidate route as non-repeatable search nodes; wherein in a direction of path extension along the starting point of the candidate route to the ending point of the candidate route, a parent node of each node on the candidate route is located at a node position adjacent to the each node.

Alternatively, wherein in step 4, when the child node searched in step 3 is an ending point of the candidate route in the pre-searched candidate route coordinate set, storing an starting point of the candidate route in the cache space of the nodes to be traversed and recording location information of a parent node of the starting point of the candidate route, so that starting point of each candidate route in the pre-searched candidate route coordinate set is used as a route identification information, and setting all intermediate nodes between the two endpoints of the candidate route and the starting point of the candidate route as non-repeatable search nodes; wherein in a direction of path extension along the ending point of the candidate route to the starting point of the candidate route, the parent node of each node on the candidate route is located at a node position adjacent to the each node.

Alternatively, wherein in step 5, based on the location information of the parent node recorded, connecting the child node with its parent node successively except for all the intermediate nodes and the endpoint of the candidate route in step 4, from the navigation ending point and until the navigation starting point, includes: step 51, based on the location information of the parent node recorded, connecting the navigation ending point with a parent node of the navigation ending point from the navigation ending point, and then performing step 52; step 52, updating a currently determined parent node as the child node, and then connecting the child node with a parent node of the child node based on the location information of the parent node recorded; step 53, performing step 52 repeatedly until connected to one endpoint of the candidate route in step 4, then from other endpoint of the candidate route in step 4, connecting the other endpoint of the candidate route in step 4 with a parent node of the other endpoint, and then performing step 52; step 54, performing the step 52 and step 53 repeatedly until connected to the navigation starting point, to obtain a navigation path from the navigation starting point to the navigation ending point.

Alternatively, wherein in step 5, a sum of the path cost is obtained by adding or weighting a cost of a traversed path and a cost of a predicted path, and the cost of the traversed path is a cost of a specified node in the cache space of the nodes to be traversed from the navigation starting point; the cost of the predicted path is a cost of the specified node in the cache space of the nodes to be traversed from the navigation ending point; and a specified node with a smaller sum of the path cost have a higher traversal priority in the cache space of the nodes to be traversed; wherein, a cost of a path between two adjacent nodes is represented by Manhattan distance, Hierarchical distance or Euclidean distance.

Alternatively, from the navigation starting point, connecting each traversed center point of the grid successively until the specified node, then obtaining a length of the current connected line by an edge length of the grid, and setting the length of the current connected line as the cost of the traversed path; setting the specified node as the parent node, and then obtaining all connection schemes of each child of the parent node to the navigation ending point, then obtaining a length of each of all the connection schemes of the each child node by the edge length of the grid, and selecting a shortest length corresponding to the each child node as the cost of a predicted path of the each child node; wherein the grid point is represented by the center point of the grid, and the grid point is used to represent a positional feature of a grid.

Alternatively, wherein the path fusing and planning method also includes: creating a traversed node cache space for storing the non-repeatable search nodes set in step 4; wherein nodes in the traversed node cache space are not allowed to be stored in the cache space of the nodes to be traversed.

Alternatively, wherein the step 4 also includes: in a case that all free grid points in a neighborhood of the current parent node are stored in the cache space of the nodes to be traversed, removing the current parent node from the cache space of the nodes to be traversed, and then storing the current parent node into the traversed node cache space.

Alternatively, wherein before the path fusing and planning method is performed, a search method for the candidate route in the pre-searched candidate route coordinate set, specifically includes: step 101, controlling the robot to move along a preset path until it is determined that a pre-search region satisfies a first preset circle domain passage condition, and then performing step S302; step S302, recording a current position of the robot as a first path node, and creating a set of predicted passage coordinates at the same time, and storing the first path node to the set of predicted passage coordinates, and then performing step S303; step S303, controlling the robot to move along the preset path until it is determined that a linear distance between a current position of the robot and a newly recorded path node is greater than or equal to a diameter of a body of the robot, and then performing step S4; wherein the newly recorded path node is recorded as the first path node; a current position of the robot is changed as the robot move to a new position along the preset path; step S304, recording the current position of the robot in step 103 as a second path node, and determining whether the second path node satisfies a second preset circle domain passage condition, in a case that the second path node satisfies the second preset circle domain passage condition, performing step S305, in a case that the second path node does not satisfy the second preset circle domain passage condition, performing step S306; step S305, determining that the robot is currently in a narrow channel, and storing the second path node into the set of predicted passage coordinates created in step S302, and then performing step S303; step S306, determining that the robot is not in the narrow channel, and storing the set of predicted passage coordinates in the pre-searched candidate route coordinate set according to a number of path nodes stored in the set of predicted passage coordinates, and connecting the path nodes stored in the set of predicted passage coordinates in an order of successively stored, so as to obtain a candidate route; and then return to perform step S301; in one pre-searched candidate route coordinate set, a head element and a tail element in any set of the predicted passage coordinates are unique; and the head element and the tail element of one set of predicted passage coordinates are different; wherein, the narrow channel is a gap channel of two or more than two obstacles, the gap channel is a narrowest gap between the two obstacles or two of the more than two obstacles, and a width of the narrowest gap between the two obstacles is greater than or equal to the diameter of the body of the robot; the preset path is a path preplanned by the robot.

Alternatively, wherein in a case that the robot currently detects a change from being in the narrow channel to not being in the narrow channel, the step 1 to step 5 are performed to begin performing the path fusing and planning method.

Alternatively, wherein storing the set of predicted passage coordinates in the pre-searched candidate route coordinate set according to the number of the path nodes stored in the set of predicted passage coordinates, includes specifically: when the number of the path nodes stored in the set of predicted passage coordinates is less than 2, deleting the set of predicted passage coordinates, and then return to perform step S301 to create a new set of predicted passage coordinates; when the number of the path nodes stored in the set of predicted passage coordinates is greater than or equal to 2, storing the set of predicted passage coordinates to the pre-searched candidate route coordinate set so that a new candidate route is saved, and then returning to perform step S301 to create a new set of predicted passage coordinates; wherein, the first path node and the second path node are stored in the set of predicted passage coordinate in a recorded order, so that the path nodes stored in the set of predicted passage coordinate are connected into one candidate route in a certain sequence; wherein, a path node corresponding to the head element in the set of predicted passage coordinate is a starting point of one candidate route, and a path node corresponding to the tail element in the set of predicted passage coordinates is an ending point of one candidate route.

Alternatively, wherein the first preset circle domain passage condition includes: a proportion of an area of a first non-passable region in the pre-search region is greater than a first passage assessment value; wherein, the first non-passable region is within a grid region corresponding to a first circular region, and the grid region is composed of unknown grid points and obstacle grid points; the first passage assessment value is a prediction threshold set to overcome marking errors of the free grid marked in a constructed grid map; wherein, the pre-search region is the first circular region with a current position of the robot as a center of the circle and the diameter of the body of the robot as a radius.

Alternatively, wherein the second preset circle domain passage condition includes: in a second circular region with a current position of the robot as a center of a circle and the diameter of the body of the robot as a radius, a proportion of a second non-passable region in a pre-search region is greater than a second passage assessment value; wherein, the second non-passable region is a grid region corresponding to the second circular region, and the grid region is composed of unknown grid points and obstacle grid points; the second passage assessment value is a judgment threshold set to overcome marking errors of the free grid marked in a constructed grid map, and the second passage assessment value is greater than the first passage assessment value.

Alternatively, wherein the second preset circle domain passage condition includes: in a second circular region with the first path node recorded last in step S302 as a center of a circle and a preset multiple of the diameter of the body of the robot as a radius, using a path search algorithm to search a path from a second path node recorded last in step S304 to a first path node recorded last in step S302; wherein the preset multiple of the diameter of the body of the robot is set as: the second circular region does not cross with other marked grid region.

A chip, having a program code stored thereon, wherein, the program code is configured to perform path fusion planning method.

A robot, wherein, the robot is provided with the chip; and the chip is configured to control the robot to perform the path fusing and planning method.

### BRIEF DESCRIPTION OF THE DRAWINGS

FIG. 1 is a flowchart of a path fusing and planning method for a passing region according to an embodiment of the disclosure.

FIG. 2 is a flowchart of a search method for a corresponding route within the pre-searched candidate route coordinate set according to another embodiment of the disclosure.

### DETAILED DESCRIPTION OF THE EMBODIMENTS

The specific embodiment of the invention is further explained by reference to the drawings.

To be noted, those skilled in the art can understand: environmental information around the current position of the robot is marked in the grid map, the state of a grid in the map region constructed by the robot can be marked as free, occupied, or unknown; the grid is represented by using a grid point in this embodiment, the grid point is the central point of the grid; a grid point in free state is the grid not occupied by the obstacle, which is the grid position point that the robot can reach, that is a free grid point or a free grid, to form an unoccupied region; a grid point in occupied state is the grid occupied by the obstacle, which is an obstacle grid point or an obstacle grid, to form an occupied region; an unknown grid point refers to the grid region where the specific situation is not clear in the process of constructing the map, its position point is often blocked by obstacles, to form the unknown region.

To be noted that, when using a search algorithm to solve the problem, it is necessary to construct a data structure that indicates the relationship between the state characteristics of its own position and the state of different positions, this data structure is called node. Different problems are described with different data structures. Depending on the conditions given by a search problem, starting from one node, one or more new nodes can be searched, this searched process is often called extension. The relationship between nodes can generally be expressed as adjacent parent nodes and child nodes. This searched process of the search algorithm is actually the process of finding the nodes conforming to the target state according to an initial condition and an extension rule.

It should be noted that cleaning robot in prior art often moves to the four feet of the stool in the home environment, the entrance of the tea table and other narrow channels between various furniture components, a narrow channel formed by the opening of a room door. It should be added that the narrow channel is a crevice channel between each obstacles, and the crevice channel of each obstacle is a gap corresponding to the narrowest place between the two obstacles, the width of this gap is greater than the diameter of the body of the robot, which allows the robot to pass through. Due to the robot skid, accumulated error of visual map optimization or sensor for positioning, the robot can easily mark the narrow channel as the region occupied by the obstacle on the grid map constructed by instant scanning, that is to say, free grid points to which the narrow channel is incorrectly labeled as the region occupied by an obstacle, the entrance leading to the narrow channels mapping to the constructed map is blocked, and the actual motion scene is not really blocked, so that the robot is unable to use a mature path search algorithm to plan a navigation path through the narrow channel, wherein, a mature path search algorithm includes heuristic search algorithm such as A*algorithm, or incremental heuristic search algorithm such as D*algorithm.

Therefore, the invention discloses a path fusing and planning method for a passing region. The invention needs to control robot passes through the narrow channels with more obstacles in advance to search out the candidate routes for fusion, in an original normal navigation operating state; then, the path fusing and planning method is used to integrate the heuristic search algorithm (mainly the path node search idea of this kind of search algorithm) and the candidate route that satisfies the search conditions, to plan the overall navigation path to overcome the map grid marking error, so that the navigation path planning problem of the robot in a passable region where the marking errors are easily generated due to the fact that the channels in a grid map are narrow is solved.

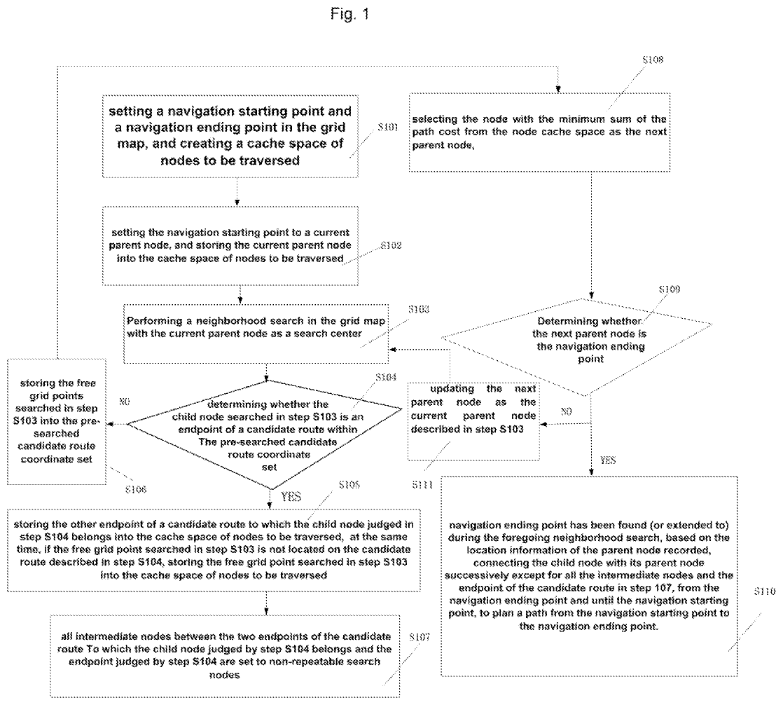

As an embodiment, the embodiment of the present invention discloses a path fusing and planning method for a passing region, which can be implemented before the robot completely leaves the narrow channel, or the robot enters a new narrow channel after leaving the current narrow channel. As shown in FIG. 1, the path fusing and planning method includes:

At step S101, setting a navigation starting point and a navigation ending point in the grid map, and creating a cache space of nodes to be traversed; then step S102 is performed. Wherein, the grid map is a local map constructed by the robot including starting points and ending points. The grid map also includes obstacle information of various layouts, and contains enough space area for the robot to plan the path trajectory according to the navigation starting point and the navigation ending point. The navigation starting point and the navigation ending point can be represented by the grid coordinates of the grid map, the grid center point coordinates, or other types of navigation data, which is not limited, but can be converted to the grid map to participate in the path planning. On the other hand, the cache space of nodes to be traversed is created in step S101 and initialized as empty, the priority of the internal element is related to the path cost, and the priority of the element includes traversal priority, or planning priority.

At step S102, setting the navigation starting point to a current parent node, specifically to the grid or the grid point where the navigation starting point is located, and storing the current parent node into the cache space of nodes to be traversed, and then step S103 is performed. In an alternative embodiment, before the navigation starting point is stored in the cache space of nodes to be traversed, the cache space of nodes to be traversed can be empty, then the navigation starting point is the first node stored in the cache space of nodes to be traversed. Preferably, a parent node located at the origin of the robot coordinate system (the origin of a local coordinate system) and extended search child nodes in four quadrant regions are all adjacent positional relationships.

Wherein, the cache space of nodes to be traversed is regarded as a set of candidate path nodes for the path planning of the present embodiment, and path nodes that the robot can pass through are stored in the cache space of nodes to be traversed for subsequent screening. The position of each path node and state of the robot moving to the corresponding path node are recorded into the cache space of nodes to be traversed. In this exemplary embodiment, for a path node in the grid map, the state when the robot moves to the path node is represented by state parameters, the state parameters include at least: time, that is, the time when the robot reaches the path node; the state parameters can also include: attitude, including the direction when the robot reaches the path node, steering angle (i. e., the robot itself is in a straight state or a steering state, and the steering angle), speed, the movement speed when the robot reaches the path node. At the beginning of the path planning, robot can first determine the state parameters of the navigation starting point, wherein, current time or zero time is regarded as a moment when the robot is at the navigation starting point; the attitude and the speed corresponding to the navigation starting point is taken as a current motion state of the robot, such as the start of the robot as the stationary state, for example, if a starting motion state of the robot is in the stationary state, the steering angle and speed corresponding to the navigation start point are both 0. In an exemplary embodiment, the cache space of nodes to be traversed is a data structure of the priority queue; the corresponding candidate path nodes are stored in the storage space of the robot in a first-in, first-out storage order.

At step S103, performing a neighborhood search in the grid map with the current parent node as a search center, to search for child nodes of the current parent node, wherein, 8 grid points adjacent to the current parent node are respectively as a child node of the current parent node; and step S104 is performed. Wherein the process of searching for a child node on the neighborhood from the parent node (the current parent node set in step S102) is regarded as an extension. In the process of one extension, search clockwise in the neighborhood of the current parent (neighborhood search), or counterclockwise in the neighborhood of the current parent (neighborhood search), so as to search out the child nodes that satisfy relevant conditions.

At step S104, determining whether the child node searched in step S103 is an endpoint of a candidate route within the pre-searched candidate route coordinate set, if so, step S105 is performed, otherwise step S106 is performed. That is to say, determining whether the child node searched in step S103 belongs to a starting point of the candidate route or an ending point of the candidate route within the pre-searched candidate route coordinate set, so as to connect a planned navigation path to the candidate route to which the searched child node belongs, for actual navigation walking, without considering the impact of the error of the marker information on the grid points detected in real time on the navigation path planned by conventional mature path search algorithms, in particular, mismarking the free grid point as an obstacle grid point, so that the navigation path planned by the conventional mature path algorithm can not pass through the obstacle grid point mismarked, which is not conducive for the robot to pass through the narrow channel. Wherein, if one endpoint of the candidate route is the starting point, the other endpoint of the candidate route is the ending point; and when one endpoint of the candidate route is the endpoint, the other end point of the candidate route is the starting point.

At step S105, storing the other endpoint of a candidate route to which the child node judged in step S104 belongs into the cache space of nodes to be traversed, the other endpoint of a candidate route to which it belongs is stored in the cache space of nodes to be traversed, a candidate route to which the child node judged in step S104 belongs is regarded as the candidate route; at the same time, if the free grid point searched in step S103 is not located on the candidate route described in step S104, storing the free grid point searched in step S103 into the cache space of nodes to be traversed, making the cache space of nodes to be traversed as a collection of subsequent candidate nodes used for path planning, at the same time, recording the location information of the parent node of the nodes stored in the cache space of nodes to be traversed, and storing the location information recorded of the node together with the location information of the corresponding parent node into the cache space of nodes to be traversed; preferably, storing the time, attitude, speed and other information of the child node and its parent node into the cache space of nodes to be traversed; among the nodes stored in the node cache space in step S105, except for the other endpoint of a candidate route to which the child node judged in step S104 belongs, the parent nodes of the rest nodes are regarded as the current parent nodes described in step S103; preferably, the parent node of the other endpoint of the candidate route is an adjacent node on the candidate route or outside of the candidate route, in order to search for the other endpoint, to backtrack a location information of the candidate route directly through the parent node of the other endpoint, speeding up the path planning.

To be noted that, the reason for storing one of the endpoints of the candidate route instead of two endpoints and intermediate nodes between the two endpoints of the candidate route in the cache space of nodes to be traversed is that: the candidate route is pre-searched, before performing the path fusing and planning method, it is known to search out a set of relevant coordinate points and can be successively connected into path segments, one of the endpoints of the candidate route can be used as an identification of the candidate route or as an index of the starting point on the candidate route, therefore, only the other endpoint (equivalent to an unsearched path node) of the candidate route to which an endpoint of the neighborhood search belongs is stored in the cache space of nodes to be traversed, so as to search for new passable nodes associated with the candidate route by centering on the endpoint stored in the cache space of nodes to be traversed, for the free grid of the neighborhood belonging to the current parent node that is not on the candidate route corresponding to step S104, to provide a free grid with the shortest path base.

Therefore, as shown in FIG. 1, in the process of performing step S107, all intermediate nodes between the two endpoints of the candidate route to which the child node judged by step S104 belongs and the endpoint judged by step S104 are set to non-repeatable search nodes. This embodiment also creates a traversed node cache space for storing non-repeatable search nodes; it should be noted that the nodes in the traversed node cache space are not allowed to be stored in the cache space of nodes to be traversed, so that in the planning process, identifying the nodes that have been traversed or regarded as searched out, to avoid repeated search. Wherein, the step S105 and the step S107 can be performed simultaneously. After performing the step S107, step S108 is performed.

Preferably, if a free grid points in the neighborhood of the current parent node that is not located on the candidate route, and all the free grid points in the neighborhood of the current parent node are stored into the cache space of nodes to be traversed, removing the current parent node from the cache space of nodes to be traversed, and storing the current parent node into the traversed node cache space, preventing the repeated extension of the same search center, since the current parent node has been extended once in step S103. The traversed node cache space can exist inside the robot as a list such as a data storage structure.

Note that a candidate route within the pre-searched candidate route coordinate set is allowed to cross the obstacles grid point marked on the grid map, regardless of whether this obstacles grid point is marked for the map error.

In this embodiment, the grid point marking error is formed in the grid map due to errors such as sensor error, map drift error, or obstacle movement.

At step S106, when the child node searched in step S103 is not the endpoint of the candidate routes in the pre-searched candidate route coordinate set, storing the free grid points searched in step S103 into the pre-searched candidate route coordinate set, and recording the location information of the parent node of the free grid point searched in step S103, and then step S108 is performed. So that, the search range of child nodes in the neighborhood search can be extended, so as to search starting points and ending points in the pre-searched candidate route coordinate set in a larger range, making the planned path more practical and representative.

As an embodiment of step S105, when the child node searched in step S103 is the starting point of the candidate route within the candidate route coordinate set, an ending point of the candidate route is stored in the cache space of nodes to be traversed and the location information of the parent node of the ending point of the candidate route is recorded, so that the ending point of each candidate route in the pre-searched candidate route coordinate set is used as a route identification information, and all intermediate nodes between the two endpoints of the candidate route and the starting point of the same candidate route are set to the non-repeatable search nodes. In the direction of path extension along the starting point of the candidate route to its ending point, the parent node of each node on the candidate route is located at the node position adjacent to the node. Specifically, in the candidate route coordinate set, starting from the starting point of the candidate route, extending from the starting point of the candidate route, along a first path extension direction in which the starting point of the candidate route points to the ending point of the candidate route, the location information of the parent node of each node of the candidate route is successively recorded until the location information of the parent node of the ending point of the candidate route is recorded, wherein the parent node of each node of the candidate route is its adjacent node in the first path extension direction. Therefore, the parent node of the ending point of the candidate route is outside the candidate route and adjacent to the ending point of the candidate route, and the child node of the ending point of the candidate route is on the candidate route and adjacent to the ending point of the candidate route; and the parent node of the starting point of the candidate route is located on and adjacent to the starting point of the candidate route, the child node of the starting point of the candidate route is located on and adjacent to the starting point of the candidate route.

As another embodiment of step S105, when the child node searched in step S103 is the ending point of the candidate route within the candidate route coordinate set, a starting point of the candidate route is stored in the cache space of nodes to be traversed and the location information of the parent node of the starting point of the candidate route is recorded so that each candidate route uses the starting point as route identification information; and all intermediate nodes between the two endpoints of the candidate route and the ending point of the same candidate route are set to the non-repeatable search nodes. Wherein along the ending point of the candidate route to the path extension direction of its starting point, the parent node of each of the candidate routes is located at the node position adjacent to the node. Concretely, within the candidate route coordinate set, starting from the ending point of the candidate route, in a second path extension direction along the ending point of the candidate route, the location information for the parent node of each node of the candidate route is successively recorded until the location information of the starting point of the candidate route is recorded, wherein the parent node of each node of the candidate route is its adjacent node in the second path extension direction. Therefore, the parent node of the starting point of the candidate route is outside the candidate route and adjacent to the starting point of the candidate route, and the child node of the starting point of the candidate route is on the candidate route and adjacent to the starting point of the candidate route; and the parent node of the starting point of the candidate route is located on and adjacent to the starting point of the candidate route, the child node of the starting point of the candidate route is located on and adjacent to the starting point of the candidate route.

Based on the two embodiments of step S105, the starting point or the ending point of the candidate route is configured to be a node that can uniquely determine a candidate route, the node that can uniquely determine a candidate route is an identification of a candidate route and record information of the parent node of this node, while the remaining nodes of the candidate route are configured as nodes that have been searched repeatedly, reducing the amount of searches during path planning, and accelerating the backtracking of a matching candidate route.

At step S108, selecting the node with the minimum sum of the path cost from the node cache space as the next parent node, and step S109 is performed. In this embodiment, a node with a higher priority is selected as the next parent node by comparing the path cost of each node in the cache space of nodes to be traversed; wherein a node with a smaller sum of the path cost have a higher priority, and a node with the smallest (highest priority) sum of the path cost serves as the next parent node, starting a new neighborhood search, continuing with the next parent node as the center search and storing a new neighborhood grid point (distinguished from nodes that already exist in the cache space of nodes to be traversed).

In this embodiment, the sum of the path cost is obtained by adding or weighting a cost of a traversed path and a cost of a predicted path, wherein the cost of a traversed path is the cost of a specified node in the cache space of nodes to be traversed distance from the navigation starting point, the cost of a predicted path is the cost of the same specified node in the cache space of nodes to be traversed distance from the navigation ending point, and the path cost is defined as an Heuristic function of the A*algorithm. Wherein a node with a smaller sum of the path cost have a higher traversal priority in the cache space of nodes to be traversed; this embodiment is based on the Heuristic function of the A*algorithm; the Manhattan distance, the diagonal distance or the Euclidean distance is used to calculate a cost of a path between two adjacent nodes; among, if the robot is currently located in only four directions in the map region, such as up, down, left and right, the Manhattan distance can be used; if the robot is currently located in eight directions in the map region, the diagonal distance can be used; if the robot is currently located in any direction in the map region, the Euclidean distance can be used. It is beneficial to find out the shortest path with the lowest path cost.

In calculating the path cost, starting from the navigation starting point, connecting each traversed center point of the grid successively until connected to the specified node, then obtaining a length of the current connection by an edge length of the grid, and setting the length of the current connection as the cost of the traversed path; in calculating the path cost, setting the specified node as the parent node, and then obtaining all the connection schemes of each child of a currently set parent node to the navigation ending point, then obtaining the length of each connection scheme of each child node by an edge length of the grid, and the shortest length corresponding to each child node is selected as its corresponding cost of a predicted path; wherein the grid point is represented by the center point of the grid, and the grid point is used to represent a positional feature of a grid. The path cost calculated in this embodiment is a measure of the cost of the robot movement trajectory, indicating the cost of moving from the starting point to the specified node and then moving to the ending point, the path cost including the path length.

It should be noted that for each node, its path cost can be calculated. The path cost is a measure of the cost of the movement trajectory of the robot, which represents the cost of moving from the starting point to the node and then to the ending point, including the path length, the required time, whether the collision occurs, whether the speed direction is switched on frequently and other factors.

At step S109, determining whether the next parent node is the navigation ending point, then step S110 is performed, otherwise step S111 is performed.

At step S111, updating the next parent node as the current parent node described in step S103, and step S103 is performed.

For the grid map, the embodiment corresponding to the foregoing steps constantly search to the navigation ending point by starting from the navigation starting point, and connects the searched node with the candidate route, in order to form a final planned navigation path. Therefore, the step S111 is a trigger step belonging to the cycle execution, and each time performing the step S103 is an extension, so that the robot starts moving from the current parent node, after a preset interval time, the node the robot can reach is the child node; in short, each extension means that the robot “takes one step”, corresponding to crossing a grid in the map. It should be noted that the preset interval time is the periodic time of each expansion, which represents a time unit, such as 5 seconds, 10 seconds, etc. The shorter the preset interval time, the more detailed the planned navigation path, so the preset interval time can be determined according to the actual requirements.

In this embodiment, in the subsequent extension of the next parent node for the search center, if the current parent node is regarded as the child node searched in the neighborhood, the current parent node is not stored in the cache space of nodes to be traversed.

At step S110, it is determined that the navigation ending point exists in the cache space of nodes to be traversed, that is, the navigation ending point has been found (or extended to) during the foregoing neighborhood search, based on the location information of the parent node recorded, connecting the child node with its parent node successively except for all the intermediate nodes and the endpoint of the candidate route in step 107, from the navigation ending point and until the navigation starting point, to plan a path from the navigation starting point to the navigation ending point.

Compared to the solutions known to inventor, the foregoing embodiment of the control robot at the same position, starting from the navigation starting point, the node with the minimum sum of path cost from the cache space of nodes to be traversed is selected successively as the parent node for neighborhood search, and storing free grid points not located on the candidate route and an identification endpoint on the candidate route (a starting point or an ending point) into the cache space of nodes to be traversed, and record the corresponding parent node as backtracking information of the node, Excluding the interference of repeated searches from the intermediate nodes on the candidate route (although all are the navigation points for narrow channels), until the parent node is set as a navigation ending point. According to a position relationship between the child node and the parent node, the candidate route found is reverse connected to the navigation starting point from the navigation ending point, thus, the candidate routes that satisfy the passage conditions are fused into the heuristic search algorithm to plan a navigation path, overcoming the narrow channel in the map grid due to marking errors, making the robot effectively enter and exit the narrow channel along the planned overall navigation path, reducing the probability of path navigation failure.

Specifically, when it is determined that the next parent node is the navigation ending point, based on the location information of the recorded parent node, except for all intermediate nodes of the candidate route and the endpoint stored in step S107, starting from the foregoing navigation ending point, connecting the child node with its parent node successively until connected to the navigation starting point, includes:

At step 51, based on the location information of the foregoing recorded parent node or the location information of the parent node and the child node stored in the cache space of nodes to be traversed, starting from the navigation ending point, connecting the navigation ending point with the parent node; and then step 52 is performed. Thus, it starts to reverse connect node by node.

At step 52, updating a currently determined parent node as the child node, based on the location information of the foregoing recorded parent node, connecting the child node with the parent node of the child node based on the location information of the foregoing recorded parent node; and then step 53 is performed.

At step 53, repeatedly performing the step 52 until it is connected to an endpoint of the candidate route described in step S105, then starting from the other endpoint of the candidate route described, connecting the other endpoint of the candidate route to its parent node, and then step 52 is performed. Wherein the parent node of the other endpoint of the candidate route is: adjacent to the other endpoint of the candidate route and located outside of the candidate route, which is in the direction of path extension along an endpoint of the candidate route to the other endpoint stored in step S105.

As an embodiment, when it is connected to the starting point of the candidate route described in step S105, based on the foregoing embodiment, the starting point of the candidate route is the parent node of the child node updated at step 52, that is, the starting point of the candidate route becomes the parent node of a node adjacent to it, in the opposite direction of the direction of a path extension along the starting point of the candidate route to its ending point, so as to determine the direction of path extension along the starting point of the candidate route to its ending point, the parent node of each node on the candidate route is located at a node position adjacent to the node, at the same time, the starting point and intermediate nodes of the candidate route are regarded as non-repeatable search nodes, that is to say, the non-repeatable search node is a path node that has been traversed. So at step 53, connecting the ending point of the candidate route with its parent node from starting at the starting point of the candidate route, because the parent node of the ending point of the candidate route is outside of the candidate route to return to perform the step 52 to continue backtracking to the outer region of the candidate route.

As another embodiment, when it is connected to the ending point of the candidate route described in step S105, based on the foregoing embodiment, the ending point of the candidate route is the parent node of the child node updated at step 52, that is, the ending point of the candidate route becomes the parent node of a node adjacent to it, in the direction of a path extension along the starting point of the candidate route to its ending point, so that the path extension direction from the ending point of the candidate route to its starting point, the parent node of each node on the candidate route is located at a node position adjacent to the node, at the same time, the starting point and intermediate nodes of this candidate route are non-repeatable search nodes, that is to say, the non-repeatable search node is path node that has been traversed. So at step 53, connecting the starting point of the candidate route with its parent node by starting from the starting point of the candidate route, because the parent node of the starting point of the candidate route is outside of the candidate route, so as to return to step 52 to continue backtracking to the outer region of the candidate route.

At step 54, repeatedly performing the foregoing step 52 and the foregoing step 53 until the navigation starting point is connected to reverse the connection of the parent node searched from step S101 to step S111, based on the location information of the recorded parent node to obtain a navigation path from the navigation starting point to the navigation ending point.

In the process of performing step 51 to step 54, based on the location information of the foregoing recorded parent node, connecting the child node (including the endpoint of the candidate route) with the parent node of the child node and then updating a currently determined parent node as the child node, such that the process of performing step 51 to step 54 can be called “reverse extension”, essentially starting from the navigation ending point, through the extension of the starting point or the ending point of the candidate route until reaching the navigation starting point, that is the reverse extension trajectory, i. e., obtain the candidate route connecting the navigation starting point, the navigation route that can cross obstacle grid points, and the navigation ending point.

Compared to the prior art, after planning the foregoing navigation path in the foregoing steps, this embodiment is realized: as the robot passes through a narrow channel, when searching for paths by using a heuristic search algorithm or an incremental heuristic search algorithm; if a narrow channel is detected, in the neighborhood of the narrow channel, the robot is adjusted from entering a navigation path searched by the heuristic search algorithm or the incremental heuristic search algorithm to entering the candidate route; if the robot has left a narrow channel, the robot is adjusted from entering the candidate route to entering a navigation path searched by the heuristic search algorithm or the incremental heuristic search algorithm; so that allowing the robot to effectively cross the narrow channel, also improving navigation success rates through the narrow channels.

Preferably, the state parameters of each node can also be marked in the navigation path, wherein the state parameters of each node include the time of each node, the moment when the robot moves to each node as planned. Therefore, the state parameters can be added to the navigation path, such as the moment of each node in the navigation path, when the narrow channel exists in the map, can calculate whether the robot trapped in the narrow channel for a long time, so as to achieve effective path planning in a complex obstacle distribution environment, satisfying the actual demand.

It is worth noting that if there is no new child node to store in the cache space of nodes to be traversed, which cannot be extended in the neighborhood, it can mean that there are insurmountable obstacles in the map, such as the channel formed between obstacles is less than the diameter of the body of the robot.

Furthermore, if the times of repeatedly performing steps 52 to 53 has reach a certain number, the navigation starting point is still not connected, indicating that process of the repeatedly performing step 52 to step 53 can be abnormal, and the certain number can be related to the distance between the navigation starting point and the navigation ending point.

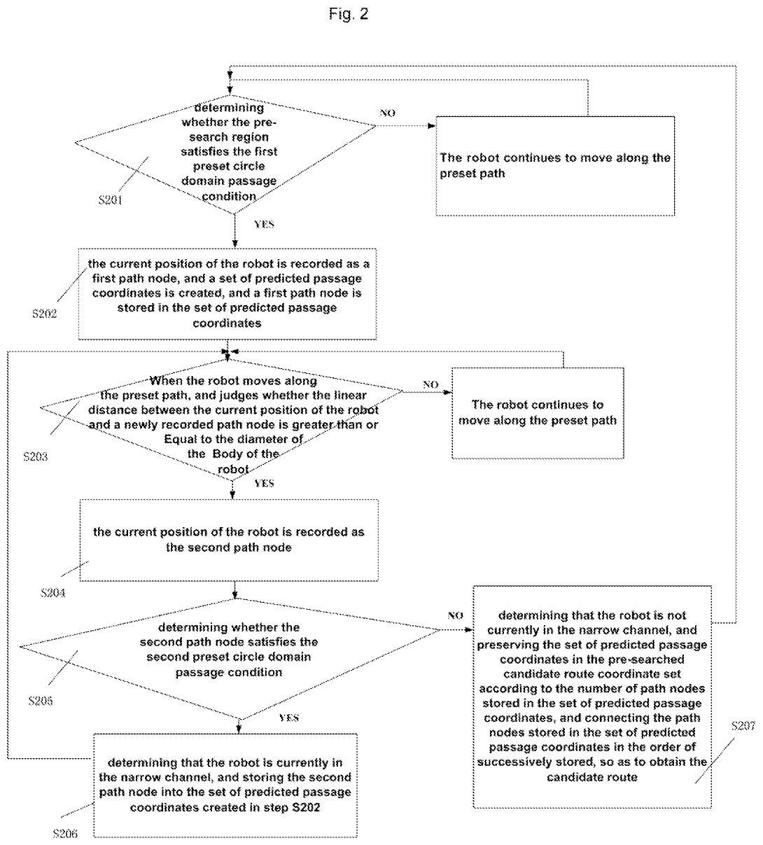

As another embodiment, the present invention further discloses a search method for the candidate route in the pre-searched candidate route coordinate set, performed before performing the path fusing and planning method, as shown in FIG. 2, specifically comprising:

At step S201, in the process of controlling the robot moving along the preset path, determining whether the pre-search region satisfies the first preset circle domain passage condition, then step S202 is performed, otherwise the robot is continued to move along the preset path. Wherein the preset path is a preplanned path; a path node can be represented by a grid point; the preset path is a normal working path or a navigation path; when the robot is a cleaning robot, the preset path can be a Z-shaped path, a walking path along edge or a square-shaped path. The robot moving on the preset path can search a route coordinate point or route during crossing the narrow channel, or search a route during entering the narrow channel. It should be noted that the pre-search region is a first circular region with the current position of the robot as the center of the circle and the diameter of the body of the robot as the radius, covering the minimum passable area around the robot.

At step S202, the current position of the robot is recorded as a first path node, and a set of predicted passage coordinates is created, and a first path node is stored in the set of predicted passage coordinates, and then step S203 is performed. In this embodiment, the elements within the set of predicted passage coordinates are configured to store the nodes sequentially, to form a set of path nodes of a route, among, a head element and a tail element within the set of predicted passage coordinate are unique, so that the head element or the tail element within the set of predicted passage coordinate becomes the unique identification information of the route, which can be used as an index node in the process of planning a path or as a marked node during backtracking path, the head elements and their tail elements within the set of predicted passage coordinates are not the same. On the other hand, if the head elements and their tail elements within the set of predicted passage coordinates are the same, elements within the set of predicted passage coordinates form closed figures in the order of the recording, leading to form a path without navigational significance.

At step S201 of the present embodiment, if the robot determines that the pre-search region satisfies the first preset circle domain passage condition, the current position of the robot is a new first path node and stored in the set of predicted passage coordinates, which can be configured as the starting point of the candidate route, equivalent to the navigation starting point.

In this embodiment, the first preset circle domain passage condition includes: the proportion of the area of a first non-passable region in a pre-search region is greater than a first passage assessment value; wherein the region of a first non-passable region is a grid region composed of unknown grid points and obstacle grid points in the first circular region; the first passage assessment value is a prediction threshold set to overcome the marking errors of the free grid marked in a constructed grid map, and is the result of repeated experiments in a narrow channel; the first passage assessment value is preferably set to 50%. When the robot judges that the proportion of the area of a first non-passable region in the first circular region is less than or equal to 50%, the robot keeps moving along the preset path until the robot determines that the proportion of the area of a first non-passable region in the first circular region is greater than 50%. Therefore, the first preset circle domain passage condition is used for preliminary judgment whether the robot begins to enter the narrow channel, which belongs to a rough judgment condition, which depends on the further judgment of the robot. However, it is not necessary to consider whether the marking information of a single grid allows the robot to pass, and reduce the influence of the marking error of a grid.

At step S203, when the robot moves along the preset path, and judges whether the linear distance between the current position of the robot and a newly recorded path node is greater than or equal to the diameter of the body of the robot, if so, step S204 is performed, otherwise the robot continues to move along the preset path. The linear distance between the current position of the robot and the newly recorded path node, including the linear distance between the current position of the robot and the first path node, wherein the robot detects the linear distance between the current position and the newly recorded path node in real time, or the robot can also conduct distance sampling detection at a certain detection period, and the path node detected in real time is recorded only when certain passage conditions are met.

At step S204, when it is detected that the linear distance between the current position of the robot and the newly recorded path node is greater than or equal to the diameter of the body of the robot, the current position of the robot is recorded as the second path node, and then step S205 is performed. Wherein, the newly recorded path node is recorded as the first path node.

At step S205, determining whether the second path node satisfies the second preset circle domain passage condition, and then step S206 is performed, otherwise step S207 is performed; therefore, the path node of the newly record in step S204 includes the first path node of the last time recorded, or the second path node of the last time recorded. Wherein, the second path node recorded in current step S204 is a new second path node relative to the second path node recorded in the last performed step S204, or the first path node recorded in step S202 is a new path node. When performing from step S202 to step S203, the newly recorded path node described in step S203 is the first path node recorded in step S202, the first path node and the second path node recorded currently are stored in the set of predicted passage coordinate; The set of predicted passage coordinates being stored by the first path node and the second path node of the currently recorded is not the set of predicted passage coordinate created by the last performed step S202. When step S203 is performed repeatedly once (returned by the subsequent step) without performing step S202, the path node of the latest record as described in step S203 is the second path node recorded in the last performed step S204, the second path nodes recorded in step S204 performed each time, are stored into the set of predicted passage coordinates.

As an implementation of the second preset circle domain passage condition, the second preset circle domain passage condition includes: in a second circular region with the current position of the robot as the center of the circle (the latest recorded second circular path node) and the diameter of the body of the robot as the radius, the proportion of a second non-passable region in a pre-search region is greater than a second passage assessment value; wherein, the second non-passable region is a grid region composed of unknown grid points and obstacle grid points within the grid region corresponding to a second circular region; a second passage assessment value is a judgment threshold set to overcome the marking error of the free grid marked in the constructed grid map, and a second passage assessment value is greater than the first passage assessment value to improve the judgment accuracy. The second passage assessment value is preferably set to 75%. When the robot judges that the proportion of the second non-passable region in the grid area corresponding to the second circular region is less than or equal to 75%, step S207 is performed. Wherein, the coverage area of the second circular region is different from the coverage area of the first circular region because the position of the robot changes when it moves along the preset path; therefore, on the basis of the first circular region or on the basis of the last time search, after the robot moves to the position where is diameter of the body of the robot from the newly recorded path node, determining the proportion of the proportion of the second non-passable region in the grid area corresponding to the second circular region, without considering the influence of the marker information for a grid point, thus improving the judgment accuracy of the narrow channel. This embodiment only sets the exploration radius of the second circular region to the diameter of the body of the robot rather than a larger value, thus avoiding the control of the irrelevant (outside the detection range) grid region in the calculation and reducing the time overhead.

As another implementation of the second preset circle domain passage condition, the second preset circle domain passage condition includes: in the second circular area with the first path node recorded last as the center of the circle and a preset multiple of the diameter of the body of the robot as the radius, using a path search algorithm to search a path from the second path node to the first path node recorded last, to prove that the path search in the current second circular region is already unaffected by the obstacle or by the mismarking of the obstacle grid. Since the second circular region can be in the neighborhood of the narrow channel, so there can be obstacles occupied on the path from the second path node recorded last to the first path node recorded last, and this embodiment regards the node with a possible collision as an invalid node or an illegal node, so as to avoid these nodes when planning the path, so it is necessary to use a path search algorithms to test the accessibility of regions, The path search algorithm used in this embodiment is the A*algorithm, making effectively and quickly search in the second circular area for a navigation path from the second path node recorded last to the first path node recorded last. It should be noted that the present embodiment can regard the first circular region or the second circular region as the cleaning area. Among them, the preset multiple of the diameter of the body of the robot is set as: the second circular region does not cross with other marked grid region, so as to avoid the path planned in other marked grid region to participate in the judgment described in the step S201 and the step S205, so as to avoid misjudgment. the preset multiple of the diameter of the body of the robot is set at two-thirds of the diameter of the body of the robot so that the coverage area of the second circular region formed is greater than the coverage area of the first circular region. Compared with the prior art, in the present embodiment, the size of the second circular area is set reasonably to avoid crossing other marked grid region to store the planned route within the relevant area, to be directed to the other regions without being guided through the current narrow channel; on the other hand, by determining whether a complete navigation path from the starting point to the ending point can be planned in the second circular region, it is proved that the passable region of this second circular region can not be affected by the obstacle or by the marked position of the obstacle grid. Thus, improving the judgment accuracy of the narrow channel.

At step S206, determining that the robot is currently in the narrow channel, and storing the second path node into the set of predicted passage coordinates created in step S202 and the step S203 is performed; after the robot recognizes that its current position is in the narrow channel, it continues to move along the preset path in the narrow channel by returning to perform step S203. Therefore, in this embodiment, the robot judges whether the current position of the robot or the current search region meets the second preset circle domain passage condition when moving a linear distance of the diameter of the body of the robot after searching to the first path node; then, when the robot is currently identified as in the narrow path by the second preset circle domain passage condition, it continues to move along the preset path in the narrow channel, and continues to search a new second path node to connect the route for passing through the narrow channel. It should be noted that the narrow channel is a gap channel of two or more obstacles, and the gap channel is the narrowest gap between the two obstacles, and the width of the narrowest gap between the two obstacles is greater than or equal to the diameter of the body of the robot.

At step S207, determining that the robot is not currently in the narrow channel, and preserving the set of predicted passage coordinates in the pre-searched candidate route coordinate set according to the number of path nodes stored in the set of predicted passage coordinates, and connecting the path nodes stored in the set of predicted passage coordinates in the order of successively stored, so as to obtain the candidate route; and then return to perform step S201, so that a set of predicted passage coordinates becomes the set of points representing a candidate route within the pre-searched candidate route coordinate set; within a pre-searched candidate route coordinate set, there are multiple sets of the predicted passage coordinates described above, representing other different candidate routes, because within the pre-searched candidate route coordinate set, the first element and its tail elements within the set of predicted passage coordinates are unique.

Specifically, the method of preserving the set of predicted passage coordinates to the pre-searched candidate route coordinate set, according to the number of path nodes stored in the set of predicted passage coordinates, includes specifically: when the number of path nodes stored in the set of predicted passage coordinates is less than 2, it indicates that the robot can detect insurmountable obstacles or be trapped or has other abnormalities, so that the collected path nodes stored in the set of predicted passage coordinates are invalid node, and then the robot selects to delete the set of predicted passage coordinates, and return to perform step S201 to create a new set of predicted passage coordinates. Therefore, in this embodiment, if the number of path nodes finally obtained by a set of predicted passage coordinates is so small that it is difficult to connect into a line, the set of predicted passage coordinates can be deleted to reduce invalid nodes.

When the number of path nodes stored in the set of predicted passage coordinates is greater than or equal to 2, using the set of predicted passage coordinates to represent a single candidate route, and saving the set of predicted passage coordinates to the pre-searched candidate route coordinate set, for the path search algorithm calling, which can be used by the heuristic search algorithm, then returning to perform step S201, to create a new set of predicted passage coordinates; in this embodiment, a path node eventually obtained by a set of predicted passage coordinates can be connected as a whole route, the whole route is saved into the set of candidate route coordinates used to preserve a set of candidate routes, making the access structure of the candidate route is reasonable and orderly. Wherein, the first path node and the second path node are stored in the set of predicted passage coordinate in a recorded order, so that the path nodes stored in the set of predicted passage coordinate are connected into the candidate route in a certain sequence. It should be noted that a path node corresponding to the head element within the set of predicted passage coordinates is the starting point of the candidate route, and a path node corresponding to the tail element within the set of predicted passage coordinates is the ending point of the candidate route. So each path node in the set of predicted passage coordinates is matched and connected into a candidate route, forming a candidate route in which the robot can pass without obstacles in the corresponding region.

Compared to the prior art, the search method for the candidate route described in step S201 to step S207 is applicable to perform a route search in a state where the robot enters a narrow channel, the first preset circle domain passage condition is set as a prediction condition of the narrow channel, and then a path node source of the candidate route corresponding to the set of predicted passage coordinates is provided; And then let the robot move along an original path, then the second preset circle passage condition is set as a fine judgment condition of the narrow channel, and the grid point source of candidate routes corresponding to the set of predicted passage coordinates is provided, making the robot qualified to judge the narrow channel after moving a certain distance. The candidate routes collected by the set of predicted passage coordinates are more complete, more adapted to the marking errors in the narrow channels, so as to provide the robot with a practical and passable route without paying real-time attention to the corresponding grid marking information. In addition, on this basis, when the corresponding preset circle domain passage conditions (such as the first preset circle domain passage condition) are not satisfied, stopping the search for the set of predicted passage coordinates, and determining that path nodes within the set of predicted passage coordinates can be connected as an independent candidate route. By iteratively performing the foregoing steps, the robot searches for a set of route points that can overcome the problem of grid unpassable due to map drift error, increasing a success rate of the robot to find the effective moving path in an environment with more complex obstacle space layout.

In particular, it should be noted that obstacle grid points are allowed to be included within a set of predicted passage coordinates, indicating that the candidate routes can have the presence of obstacle grid points. According to the step S201 to step S207, when the robot itself moves to a particular path node, such as, the current position of the robot corresponding to step S202 (satisfying the initial state condition) or in the process of performing step S206, and it is judged at the path node that the first preset circle domain passage condition or the second preset circle domain passage condition are satisfied, the path node is stored in the set of predicted passage coordinates, which is as a path node connected to the candidate route. However, due to the sensor detection error, the map drift error, etc., the marked grid information on the grid map can not be in an free state, but instead mismarked as an obstacle occupied state, that is, the obstacle grid point. Although the path node is marked as an obstacle grid point in the grid map, it is stored in the set of predicted passage coordinates, making a path node on the candidate route. In fact, robot can move to the path node, to prove that the path node is passable or connected.

On the basis of the foregoing embodiment, if the robot currently detects a change from being in the narrow channel to not being in the narrow channel, the path fusion planning method is performed, that is, the foregoing step S101 to step S111 are performed iteratively to plan a navigation path supporting the robot to enter and exit the narrow channel freely, and overcome the map drift error. Thus, before the robot leaves the narrow channel or enter the new narrow channel by leaving the current narrow channel, the searched coordinate points adapted to candidate routes crossing the narrow channel are fused into the current position of the robot, so as to use a heuristic search algorithm to plan a navigation path instead of relying on neighborhood search for navigation path planning, and overcome the problem that the planned path cannot pass through the narrow channel due to the free grid point searched at the narrow channel can easily be marked as a obstacle grid point.

A chip, having a program code stored thereon, wherein, when the program code is performed by the chip, the path fusing and planning method described in any of the foregoing embodiment. The chip is used to plan a navigation path by fusing the heuristic search algorithm and the candidate route satisfying search conditions in the narrow channel with many obstacles, so as to overcome the problem of the marked error in the grid map due to the fact that the channels in a grid map are narrow; the robot is configured to walk along the planned overall navigation path effectively in and out of the narrow channel, reducing the probability of path navigation failure in environment with more complex obstacle space layout.

A robot, wherein, the robot is provided with the chip according to the foregoing embodiment; and the chip is used to control the robot to perform the path fusing and planning method. In the process of the navigation path planned by the robot according to the path fusing and planning method through the narrow channel, when the heuristic search algorithm or the incremental heuristic search algorithm is used for the path, if a narrow channel is detected, in the neighborhood of the narrow channel, the robot is adjusted from entering a navigation path searched by the heuristic search algorithm or the incremental heuristic search algorithm to entering the candidate route; if the robot has left a narrow channel, the robot is adjusted from entering the candidate route to entering a navigation path searched by the heuristic search algorithm or the incremental heuristic search algorithm, making the robot walk along a navigation path formed by connecting the candidate routes, so as to allow the robot to cross the narrow channel effectively, navigation success rates through narrow channels is improved.

The above embodiments are merely for illustrating the technical concept and characteristics of the disclosure, and the purpose thereof is to enable those skilled in the art to understand the content of the disclosure and implement the content accordingly, and cannot limit the protection scope of the disclosure with this. All equivalent transformations or modifications made according to the spirit of the disclosure shall fall within the protection scope of the disclosure.

1. A path fusing and planning method for a passing region, the path fusing and planning method comprising:
step 1, setting a navigation starting point and a navigation ending point in a grid map, and creating a cache space of nodes to be traversed,
step 2, setting the navigation starting point to a current parent node, and storing the current parent node into the cache space of the nodes to be traversed;
step 3, performing a neighborhood search in the grid map with the current parent node as a search center, to search for child nodes of the current parent node, wherein, 8 grid points adjacent to the current parent node are respectively as a child node of the current parent node;
step 4, when a child node searched in step 3 is an endpoint of a candidate route within a pre-searched candidate route coordinate set, storing other endpoint of the candidate route into the cache space of the nodes to be traversed; meanwhile, setting all intermediate nodes between two endpoints of the candidate route and the endpoint searched in the pre-searched candidate route coordinate set to be non-repeatable search nodes, and storing free grid points not located on the candidate route into the cache space of the nodes to be traversed; then performing step 5; wherein the candidate route is allowed to pass through obstacles grids point marked on the grid map; all the nodes stored in the cache space of the nodes to be traversed are recorded with location information of their parent node to trace back nodes later;
step 5, selecting a node with a minimum sum of a path cost from the cache space of the nodes to be traversed as a next parent node, then determining whether the next parent node is the navigation ending point, in a case that the next parent node is the navigation ending point, based on the location information of the parent node recorded, connecting the child node with its parent node successively except for all the intermediate nodes and the endpoint of the candidate route in step 4, from the navigation ending point and until the navigation starting point, to plan a path from the navigation starting point to the navigation ending point; in a case that the next parent node is not the navigation ending point, updating a next parent node as the current parent node in step 3, and then performing step 3.

2. The path fusing and planning method for the passing region according to claim 1, step 4 also comprising:
when the child node searched in step 3 is not the endpoint of the candidate routes in the pre-searched candidate route coordinate set, storing free grid points searched in step 3 into the cache space of the nodes to be traversed, and recording location information of parent node of the free grid points searched in step 3, and then performing step 5.

3. The path fusing and planning method for the passing region according to claim 1, wherein in step 4, when the child node searched in step 3 is a starting point of the candidate route in the pre-searched candidate route coordinate set, storing an ending point of the candidate route in the cache space of the nodes to be traversed and recording location information of a parent node of the ending point of the candidate route, so that ending point of each candidate route in the pre-searched candidate route coordinate set is used as a route identification information, and setting all intermediate nodes between the two endpoints of the candidate route and the starting point of the candidate route as non-repeatable search nodes;
wherein in a direction of path extension along the starting point of the candidate route to the ending point of the candidate route, a parent node of each node on the candidate route is located at a node position adjacent to the each node.

4. The path fusing and planning method for the passing region according to claim 1, wherein in step 4, when the child node searched in step 3 is an ending point of the candidate route in the pre-searched candidate route coordinate set, storing an starting point of the candidate route in the cache space of the nodes to be traversed and recording location information of a parent node of the starting point of the candidate route, so that starting point of each candidate route in the pre-searched candidate route coordinate set is used as a route identification information, and setting all intermediate nodes between the two endpoints of the candidate route and the starting point of the candidate route as non-repeatable search nodes;
wherein in a direction of path extension along the ending point of the candidate route to the starting point of the candidate route, the parent node of each node on the candidate route is located at a node position adjacent to the each node.

5. The path fusing and planning method for the passing region according to claim 3, wherein in step 5, based on the location information of the parent node recorded, connecting the child node with its parent node successively except for all the intermediate nodes and the endpoint of the candidate route in step 4, from the navigation ending point and until the navigation starting point, comprises:
step 51, based on the location information of the parent node recorded, connecting the navigation ending point with a parent node of the navigation ending point from the navigation ending point, and then performing step 52;
step 52, updating a currently determined parent node as the child node, and then connecting the child node with a parent node of the child node based on the location information of the parent node recorded;
step 53, performing step 52 repeatedly until connected to one endpoint of the candidate route in step 4, then from other endpoint of the candidate route in step 4, connecting the other endpoint of the candidate route in step 4 with a parent node of the other endpoint, and then performing step 52;
step 54, performing the step 52 and step 53 repeatedly until connected to the navigation starting point, to obtain a navigation path from the navigation starting point to the navigation ending point.

6. The path fusing and planning method for the passing region according to claim 5, wherein in step 5, a sum of the path cost is obtained by adding or weighting a cost of a traversed path and a cost of a predicted path, and the cost of the traversed path is a cost of a specified node in the cache space of the nodes to be traversed from the navigation starting point; the cost of the predicted path is a cost of the specified node in the cache space of the nodes to be traversed from the navigation ending point; and a specified node with a smaller sum of the path cost have a higher traversal priority in the cache space of the nodes to be traversed;
wherein, a cost of a path between two adjacent nodes is represented by Manhattan distance, Hierarchical distance or Euclidean distance.

7. The path fusing and planning method for the passing region according to claim 6, from the navigation starting point, connecting each traversed center point of the grid successively until the specified node, then obtaining a length of the current connected line by an edge length of the grid, and setting the length of the current connected line as the cost of the traversed path;
setting the specified node as the parent node, and then obtaining all connection schemes of each child of the parent node to the navigation ending point, then obtaining a length of each of all the connection schemes of the each child node by an edge length of the grid, and selecting a shortest length corresponding to the each child node as the cost of a predicted path of the each child node;
wherein the grid point is represented by the center point of the grid, and the grid point is used to represent a positional feature of a grid.

8. The path fusing and planning method for the passing region according to claim 1, wherein the path fusing and planning method also comprises:
creating a traversed node cache space for storing the non-repeatable search nodes set in step 4;
wherein nodes in the traversed node cache space are not allowed to be stored in the cache space of the nodes to be traversed.

9. The path fusing and planning method for the passing region according to claim 8, wherein the step 4 also comprises: in a case that all free grid points in a neighborhood of the current parent node are stored in the cache space of the nodes to be traversed, removing the current parent node from the cache space of the nodes to be traversed, and then storing the current parent node into the traversed node cache space.

10. The path fusing and planning method for the passing region according to claim 7, wherein before step 1, the path fusing and planning method for the passing region comprises:
step 301, controlling the robot to move along a preset path until it is determined that a pre-search region satisfies a first preset circle domain passage condition, and then performing step S302;
step S302, recording a current position of the robot as a first path node, and creating a set of predicted passage coordinates at the same time, and storing the first path node to the set of predicted passage coordinates, and then performing step S303;
step S303, controlling the robot to move along the preset path until it is determined that a linear distance between a current position of the robot and a newly recorded path node is greater than or equal to a diameter of a body of the robot, and then performing step S4; wherein the newly recorded path node is recorded as the first path node; a current position of the robot is changed as the robot move to a new position along the preset path;
step S304, recording the current position of the robot in step 103 as a second path node, and determining whether the second path node satisfies a second preset circle domain passage condition, in a case that the second path node satisfies the second preset circle domain passage condition, performing step S305, in a case that the second path node does not satisfy the second preset circle domain passage condition, performing step S306;
step S305, determining that the robot is currently in a narrow channel, and storing the second path node into the set of predicted passage coordinates created in step S302, and then performing step S303;
step S306, determining that the robot is not in the narrow channel, and storing the set of predicted passage coordinates in the pre-searched candidate route coordinate set according to a number of path nodes stored in the set of predicted passage coordinates, and connecting the path nodes stored in the set of predicted passage coordinates in a order of successively stored, so as to obtain a candidate route, and then return to perform step S301;
in one pre-searched candidate route coordinate set, a head element and a tail element in any set of the predicted passage coordinates are unique; and the head element and the tail element of one set of predicted passage coordinates are different;
wherein, the narrow channel is a gap channel of two or more than two obstacles, the gap channel is a narrowest gap between the two obstacles or two of the more than two obstacles, and a width of the narrowest gap between the two obstacles is greater than or equal to the diameter of the body of the robot;
the preset path is a path preplanned by the robot.

11. The path fusing and planning method for the passing region according to claim 10, wherein in a case that the robot currently detects a change from being in the narrow channel to not being in the narrow channel, the step 1 to step 5 are performed.

12. The path fusing and planning method for the passing region according to claim 10, wherein storing the set of predicted passage coordinates in the pre-searched candidate route coordinate set according to the number of the path nodes stored in the set of predicted passage coordinates, comprises specifically:
when the number of the path nodes stored in the set of predicted passage coordinates is less than 2, deleting the set of predicted passage coordinates, and then return to perform step S301 to create a new set of predicted passage coordinates;
when the number of the path nodes stored in the set of predicted passage coordinates is greater than or equal to 2, storing the set of predicted passage coordinates to the pre-searched candidate route coordinate set so that a new candidate route is saved, and then returning to perform step S301 to create a new set of predicted passage coordinates;
wherein, the first path node and the second path node are stored in the set of predicted passage coordinate in a recorded order, so that the path nodes stored in the set of predicted passage coordinate are connected into one candidate route in a certain sequence;
wherein, a path node corresponding to the head element in the set of predicted passage coordinate is a starting point of one candidate route, and a path node corresponding to the tail element in the set of predicted passage coordinates is an ending point of one candidate route.

13. The path fusing and planning method for the passing region according to claim 10, wherein the first preset circle domain passage condition comprises:
a proportion of an area of a first non-passable region in the pre-search region is greater than a first passage assessment value;
wherein, the first non-passable region is within a grid region corresponding to a first circular region, and the grid region is composed of unknown grid points and obstacle grid points; the first passage assessment value is a prediction threshold set to overcome marking errors of the free grid marked in a constructed grid map;
wherein, the pre-search region is the first circular region with a current position of the robot as a center of the circle and the diameter of the body of the robot as a radius.

14. The path fusing and planning method for the passing region according to claim 13, wherein the second preset circle domain passage condition comprises:
in a second circular region with a current position of the robot as a center of a circle and the diameter of the body of the robot as a radius, a proportion of a second non-passable region in the second circular region is greater than a second passage assessment value;
wherein, the second non-passable region is a grid region corresponding to the second circular region, and the grid region is composed of unknown grid points and obstacle grid points; the second passage assessment value is a judgment threshold set to overcome marking errors of the free grid marked in a constructed grid map, and the second passage assessment value is greater than the first passage assessment value.

15. The path fusing and planning method for the passing region according to claim 13, wherein the second preset circle domain passage condition comprises:
in a second circular region with the first path node recorded last in step S302 as a center of a circle and a preset multiple of the diameter of the body of the robot as a radius, using a path search algorithm to search a path from a second path node recorded last in step S304 to a first path node recorded last in step S302;
wherein the preset multiple of the diameter of the body of the robot is set as: the second circular region does not cross with other marked grid region.

16. A chip, having a program code stored thereon, wherein, the program code is configured to perform a path fusing and planning method for a passing region, the path fusing and planning method comprise:
step 1, setting a navigation starting point and a navigation ending point in a grid map, and creating a cache space of nodes to be traversed;
step 2, setting the navigation starting point to a current parent node, and storing the current parent node into the cache space of the nodes to be traversed;
step 3, performing a neighborhood search in the grid map with the current parent node as a search center, to search for child nodes of the current parent node, wherein, 8 grid points adjacent to the current parent node are respectively as a child node of the current parent node;
step 4, when a child node searched in step 3 is an endpoint of a candidate route within a pre-searched candidate route coordinate set, storing other endpoint of the candidate route into the cache space of the nodes to be traversed; meanwhile, setting all Intermediate nodes between two endpoints of the candidate route and the endpoint searched in the pre-searched candidate route coordinate set to be non-repeatable search nodes, and storing free grid points not located on the candidate route into the cache space of the nodes to be traversed; then performing step 5; wherein the candidate route is allowed to pass through obstacles grids point marked on the grid map; all the nodes stored in the cache space of the nodes to be traversed are recorded with location information of their parent node to trace back nodes later;
step 5, selecting a node with a minimum sum of a path cost from the cache space of the nodes to be traversed as a next parent node, then determining whether the next parent node is the navigation ending point, in a case that the next parent node is the navigation ending point, based on the location information of the parent node recorded, connecting the child node with its parent node successively except for all the intermediate nodes and the endpoint of the candidate route in step 4, from the navigation ending point and until the navigation starting point, to plan a path from the navigation starting point to the navigation ending point; in a case that the next parent node is not the navigation ending point, updating a next parent node as the current parent node in step 3, and then performing step 3.

17. A robot, wherein, the robot is provided with the chip according to claim 16; and the chip is configured to control the robot to perform the path fusing and planning method according to any one of claim 1.

18. The chip according to claim 16, step 4 also comprising:
when the child node searched in step 3 is not the endpoint of the candidate routes in the pre-searched candidate route coordinate set, storing free grid points searched in step 3 into the cache space of the nodes to be traversed, and recording location information of parent node of the free grid points searched in step 3, and then performing step 5.

19. The chip according to claim 16, wherein in step 4, when the child node searched in step 3 is a starting point of the candidate route in the pre-searched candidate route coordinate set, storing an ending point of the candidate route in the cache space of the nodes to be traversed and recording location information of a parent node of the ending point of the candidate route, so that ending point of each candidate route in the pre-searched candidate route coordinate set is used as a route identification information, and setting all intermediate nodes between the two endpoints of the candidate route and the starting point of the candidate route as non-repeatable search nodes;
wherein in a direction of path extension along the starting point of the candidate route to the ending point of the candidate route, a parent node of each node on the candidate route is located at a node position adjacent to the each node.

20. The chip according to claim 16, wherein in step 4, when the child node searched in step 3 is an ending point of the candidate route in the pre-searched candidate route coordinate set, storing an starting point of the candidate route in the cache space of the nodes to be traversed and recording location information of a parent node of the starting point of the candidate route, so that starting point of each candidate route in the pre-searched candidate route coordinate set is used as a route identification information, and setting all intermediate nodes between the two endpoints of the candidate route and the starting point of the candidate route as non-repeatable search nodes;
wherein in a direction of path extension along the ending point of the candidate route to the starting point of the candidate route, the parent node of each node on the candidate route is located at a node position adjacent to the each node.
